(19) United States
(12) Patent Application Publication
(10) Pub. No.: US 2007/0140160 A1
(43) Pub. Date: Jun. 21, 2007

(54) Method for dynamically allocating power of a pilot channel

(75) Inventors: Keun Moo Lee, Gyeonggi-do (KR); Kyung Won Kang, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTSTARCOM KOREA LIMITED

(21) Appl. No.: 10/569,051

(22) PCT Filed: Sep. 24, 2004
(86) PCT No.: PCT/KR04/02468

§ 371 Date: Nov. 7, 2006

(30) Foreign Application Priority Data
Sep. 30, 2003 (KR) 10-2003-0067735

(51) Int. Cl. H04Q 7/00

(52) U.S. Cl. 370/329; 370/335

(57) ABSTRACT

The present invention relates to a method for dynamically allocating the power of a pilot channel according to the load of the forward traffic channel, which can increase the capacity of a CDMA forward link. According to the present invention, the power allocated to a pilot channel is not fixed and is variable dynamically on the basis of the traffic load. The method allocates the power of a pilot channel in consideration of the difference between the loads of the first cell and the second cell. If the load of the first cell is lower than the second cell, then the first cell is enlarged and a portion of the load of the second cell is transferred to the first cell. If the load of the first cell is higher than the load of the second cell, then the first cell is reduced and a portion of the load of the first cell is transferred to the second cell. In this manner, the performance in handoff and the capacity can be improved. In other words, according to the present invention, the power of a pilot channel is allocated dynamically considering the difference between the loads of the first cell and the second cell. The present invention can be adapted to the field of technology for optimizing the design of the wireless network in CDMA system.

### TECHNICAL FIELD

The present invention generally relates to allocating power of a pilot channel and more particularly to a method for allocating the power of a pilot channel in consideration of the difference between the loads of the first cell and the second cell.

### BACKGROUND ART

Generally, the forward channel in CDMA system is comprised of an Overhead Channel (pilot, paging, sync) and a Traffic Channel. Among the total power of the forward channel the power of the Overhead Channel is fixed and the power of the Traffic Channel is variable by the traffic load and Power Control.

The power allocated to a pilot channel of the Overhead Channel generally corresponds to 15˜20% of the maximum power of the forward link. For example, if 20W is available for the power of the forward link, then the power located to a pilot channel is approximately 4W (which is about 20% of the total power of the forward link).

As described above, in the existing CDMA system, the power allocated to a pilot channel is fixed. Accordingly, if too much power is allocated to a pilot channel then the power for the traffic channel decreases while the capacity for the forward link also decreases. On the other hand if not enough power is allocated to a pilot channel then the forward coverage and the field for the handoff, which depend on the amplitude of the pilot channel decrease.

Furthermore, the mobile communication system is essentially a multi-cell structure. Therefore, if a load of one cell is too high and that of the other is too low, a fixed power for a pilot channel cannot be allocated to the other channel. Thus, the efficiency of CDMA system cannot be improved.

### DISCLOSURE OF INVENTION

Technical Problem

It is an object of the present invention to provide a method for dynamically allocating the power of a pilot channel. The present method allocates the power of a pilot channel on the basis of the loads of one cell and the other cell. According to the present invention, if the load of the first cell is lower than the second cell, then the first cell is enlarged and a portion of the load of the second cell is transferred to the first cell. If the load of the first cell is higher than the load of the second cell, then the first cell is reduced and a portion of the load of the first cell is transferred to the second cell. In this respect, as the power of a pilot channel varies on the basis of the load of the forward traffic channel the performance in handoff and the capacity can be improved.

Technical Solution

To accomplish the above object, the method according to the present invention comprises the following steps: reporting current power of the pilot channel for each sector and total traffic power to a Base Station Controller (BSC) in a Base Station Transceiver Subsystem (BTS); referring to a Neighbor Set List for each sector of the BTS; comparing a load of a first cell with a load of a second cell based on a report of a traffic load by referring to the list; if the load of the first cell is lower than the load of the second cell enlarging the first cell and transferring a portion of the load of the second cell to the first cell; if the load of the first cell is higher than the load of the second cell, reducing the first cell and transferring a portion of the load of the first cell to the second cell; calculating new power of the pilot channel based on the traffic load; after calculating the power of the pilot channel informing the BTSs of the calculated power of the plot channel; and at the BTSs having received the calculated power, setting the calculated power as the power of their pilot channels.

It is another object of the present invention to provide an equation for allocating the power of a pilot channel. The resulting power allocated to a pilot channel is calculated using the load L₁ of the first cell and the load L₂ of the second cell as below:
the power allocated to a pilot channel (Pₚᵢₗₒₜ)=Pₚ_{_{—}}_{mid}+0.5(Pₚ_{_{—}}ₘₐₓ−Pₚ_{_{—}}ₘᵢₙ)(L₂−L₁).

### BRIEF DESCRIPTION OF THE DRAWINGS

The above object and features of the present invention will become more apparent from the following description of the preferred embodiments provided in conjunction with the accompanying drawings.

FIG. 1 illustrates a process of dynamically allocating the power of a pilot channel according to the present invention.

FIGS. 2 and 3 illustrate the method for dynamically allocating the power of a pilot channel on the basis of the traffic load according to the present invention.

FIG. 4 illustrates the method for dynamically allocating the power of a pilot channel on the basis of the load of the forward traffic channel according to the present invention.

### BEST MODE FOR CARRYING OUT THE INVENTION

Now, the preferred embodiment of the present invention entitled “Method for Dynamicaly Allocating Power of a Pilot Channel” will be described referring to the accompanying drawings.

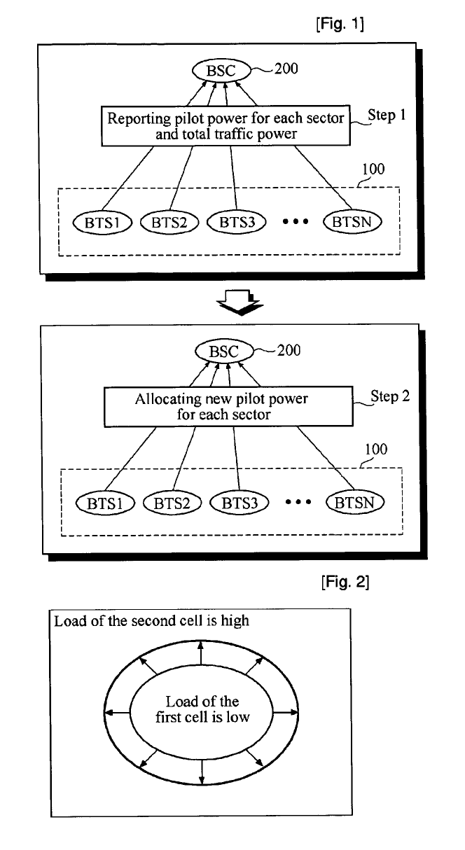

FIG. 1 illustrates the process of dynamically allocating the power of a pilot channel according to the present invention. As illustrated in FIG. 1, in the process of dynamicaly allocating the power of a pilot channel according to the present invention, each Base station Transceiver Subsystem (BTS) 100 first reports the current power of the pilot channel for each sector and total traffic power to Base Station Controller (BSC) 200 (step 1). BSC 200, which receives the report for the current power, calculates the new power of the pilot channel based on the reported traffic load and communicates it to each BTS 100 referring to a Neighbor Set List for each sector of the BTS (step 2). Then, the BTS 100 transmits the pilot channel by the new power directed from BSC 200 and returns to the initial step after a certain period.

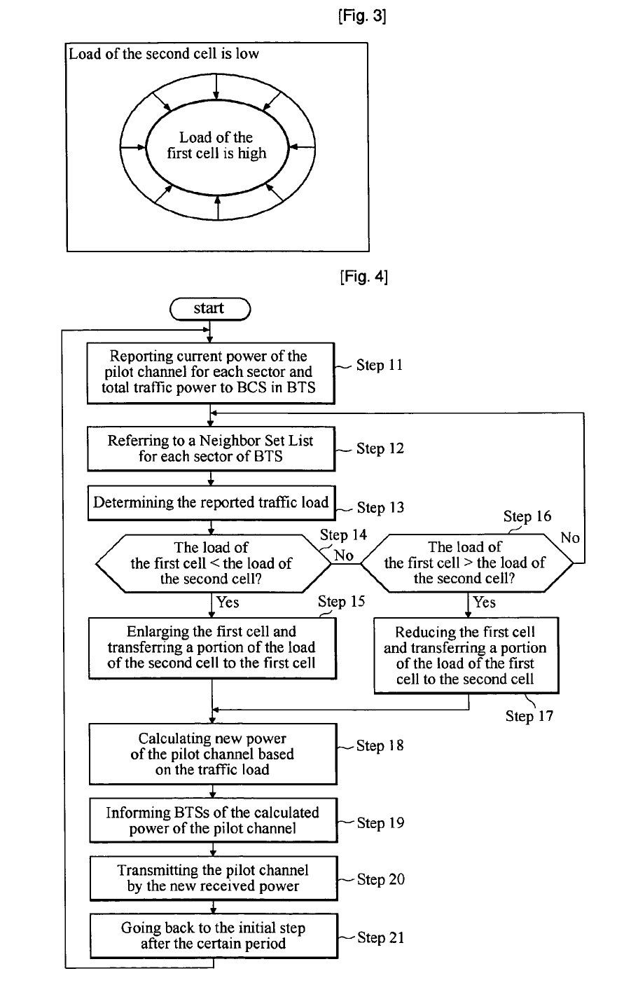

FIGS. 2 and 3 illustrate the method for dynamically allocating the power of a pilot channel on the basis of the traffic load according to the present invention. FIG. 2 illustrates the method for enlarging the cell by increasing the power of the plot channel according to the load of the pilot channel. FIG. 3 illustrates the method for reducing the cell by decreasing the power of the pilot channel according to the load of the pilot channel.

In FIGS. 2 and 3, the method allocates the power of a pilot channel in consideration of the difference between the loads of the first cell and the second cell. More specifically, as illustrated in FIG. 2, the load of a first cell is compared with the load of a second cell. If the load of the first cell is lower than the load of the second cell then the first cell will be enlarged and a portion of the load of the second cell will be transferred to the first cell. As illustrated in FIG. 3 which compares the load of the first cell with the load of a second cell if the load of the second cell is lower than the load of the first cell then the first cell will be reduced and a portion of the load of the first cell will be transferred to the second cell.

The allocated power for each sector is represented by the following equation. First, when the second cell has the M neighbor cells in the Neighbor Set List and the total traffic power of the i-th neighbor set is referred to Tᵢ, the load of the second cell is caculated as below:

$${L}_{2} = {{Q}^{M}}_{i = 1} {W}_{i} \frac{{T}_{i}}{{T}_{max}} ,$$

where, L₂ is the load of the second cell, Tₘₐₓ is the maximum value of the total traffic power, Wᵢ is a weighing factor of i-th neighbor set, and where

$${{Q}^{M}}_{i = 1} {W}_{i} = 1 ( 0 {DW}_{i} D 1 )$$

Then, the total traffic power of the first cell T₁ is represented as below:

$${L}_{1} = \frac{{T}_{1}}{{T}_{max}}$$

Next, when using the loads of the first cell and the second cell as calculated above, the resulting power Pₚᵢₗₒₜ allocated to the pilot channel is determined by the following equation:
Pₚᵢₗₒₜ=Pₚ_{_{—}}_{mild}+0.5(Pₚ_{_{—}}ₘₐₓ−Pₚ_{_{—}}ₘᵢₙ)(L₂−L₁),

where, Pₚ_{_{—}}ₘᵢₙ is the midde power value of the pilot channel, Pₚ_{_{—}}ₘₐₓ is the maximum value, and Pₚ_{_{—}}ₘᵢₙ is the minimum value.

FIG. 4 illustrates the method for dynamically allocating the power of a pilot channel on the basis of the load of the forward traffic channel according to the present invention. As illustrated in FIG. 4, the method comprises the following steps: reporting the current power of the pilot channel for each sector and total traffic power to BSC in BTS (step 11); referring to a Neighbor Set List for each sector of the BTS (step 12); comparing a load of a first cell with a load of a second cell based on a report of a traffic load by referring to the fist (step 13, 14, and 16); enlarging the first cell and transferring a portion of the load of the second cell to the first cell if the load of the first cell is lower than the load of the second cell (step 15); reducing the first cell and transferring a portion of the load of the first cell to the second cell if the load of the first cell is higher than the load of the second cell (step 17); calculating the new power of the pilot channel based on the traffic load (step 18); informing the BTSs of the calculated power of the pilot channel after calculating the power of the pilot channel (step 19); transmitting the pilot channel by the newly received power (step 20); and going back to the initial step after a certain period (step 21).

Although the specific embodiment of the method for dynamically allocating the power of a pilot channel according to the load in the forward-traffic channel is described, the present invention has many variations without departing from the scope of the present invention. Therefore, the scope of the present invention is not to be limited to the above embodiment, and it is defined by the following claims and the equivalence thereof.

### INDUSTRIAL APPLICABILITY

As described above, the method for dynamically allocating the power of a pilot channel according to a load in a forward-traffic channel is employed. If the load of the first cell is lower than the load of the second cell then the first cell will be enlarged and a portion of the load of the second cell will be transferred to the first cell. If the load of the second cell is lower than the load of the first cell then the first cell will be reduced and a portion of the load of the first cell will be transferred to the second cell. Therefore, the pilot power varies on the basis of the forward-traffic load so that the performance in handoff and the capacity can be improved.

Further, the dynamic allocation of the pilot power may change the cell coverage based on the traffic load and allocate the traffic load efficiently. As such, the capacity of the forward link can be improved.

In addition, by properly controlling the ratio of the pilot power, the interference, which occurs when the pilot power becomes fixed too high, can be decreased.

1. A method for dynamically locating a power of a pilot channel according to a load in a forward-traffic channel the method comprising the stops of:
reporting a current power of the pilot channel for each sector and a total traffic power to a Base Station Controller (BSC) in a Base Station Transceiver Subsystem (BTS);
referring to a Neighbor Set List for each sector of the BTS;
comparing a load of a first cell with a load of a second cell based on a report of a traffic load by referring to the fist;
if the load of the first cell is lower than the load of the second cell enlarging the first cell and transferring a portion of the load of the second cell to the first cell;
if the load of the first cell is higher than the load of the second cell reducing the first cell and transferring a portion of the load of the first cell to the second cell;
calculating a new power of the pilot channel based on the traffic load;
after calculating the power of the pilot channel informing the BTSs of the calculated power of the pilot channel; and
at the BTSs having received the calculated power, setting the calculated power as the power of the pilot channels.

2. The method according to claim 1, wherein when the load of the second cell has M neighbor cells in the Neighbor Set List, the load of the second cell, L₂, is calculated using a weighing factor as below:
$${L}_{2} = {{Q}^{M}}_{i = 1} {W}_{i} \frac{{T}_{i}}{{T}_{max}} ,$$
where Ti is a total traffic power of an i-th neighbor set, Tₘₐₓ is the maximum value of the total traffic power, Wᵢ is a weighing factor of i-th neighbor set, and where
$${{Q}^{M}}_{i = 1} {W}_{i} = 1 ( 0 {DW}_{i} D 1 ) .$$

3. The method according to claim 1, wherein the load of the first cell, L_{1,} is represented as below:
$${L}_{1} = \frac{{T}_{1}}{{T}_{max}} ,$$
where Ti is a total traffic power of the first sector.

4. The method according to claim 1, wherein a resulting power allocated to the pilot channel, Pₚᵢₗₒₜ, is determined by the following equation using the loads of the first cell and the second cell:
Pₚᵢₗₒₜ=Pₚ_{_{—}}_{mid}+0.5(Pₚ_{_{—}}ₘₐₓ−Pₚ_{_{—}}ₘᵢₙ)(L₂−L₁),
where, Pₚ_{_{—}}ₘₐₓ is the maximum value of the power of the pilot channel, Pₚ_{_{—}}_{mid} is the middle power value thereof, and Pₚ_{_{—}}ₘᵢₙ is the minimum value thereof.
